(19) United States
(12) Patent Application Publication
(10) Pub. No.: US 2011/0167576 A1
(43) Pub. Date: Jul. 14, 2011

(54) Soap rag

(76) Inventor: Hamiyd Muhammad, Brooklyn, NY (US)

(21) Appl. No.: 12/614,955

(22) Filed: Jan. 11, 2010

(51) Int. Cl. B08B 1/00

(52) U.S. Cl. 15/104.93

(57) ABSTRACT

A washcloth soaked in body wash soap gel, and dried to form a soap rag.

### Ingredients

Dry wash cloth

Liquid body wash gel

Drum

Heat from a Blow dryer or Dryer or hang dry

### Process of Making

Place the dry wash cloth into the drum

Pour the liquid body wash gel into the drum over the wash cloth until fully saturated

The liquid body wash gel must cover the entire wash cloth

Leave to soak

Take out soaked wash cloth and dry in a dryer or blow dry or hang dry until entire cloth is dried. This becomes a soap rag.

### Packaging

When soap rag is dried

Fold dried soap rag and package

### Usage

To use add water to soap rag

I seek to claim the following:

1. A soap rag.
